(19) United States
(12) Patent Application Publication
(10) Pub. No.: US 2015/0113420 A1
(43) Pub. Date: Apr. 23, 2015

(54) OVERLOADED SCHEDULE DETECTION AND NOTIFICATION

(71) Applicant: SugarCRM Inc., Cupertino, CA (US)

(72) Inventors: Majed Itani, San Jose, CA (US); Dmitriy Kolegayev, West Hollywood, CA (US)

(73) Assignee: SugarCRM Inc., Cupertino, CA (US)

(21) Appl. No.: 14/060,704

(22) Filed: Oct. 23, 2013

(51) Int. Cl. G06F 3/0482

(52) U.S. Cl. CPC G06F 3/0482
USPC 715/739

(57) ABSTRACT

A method, system and computer program product for overloaded schedule detection and notification in a calendaring and scheduling (C&S) system is provided. A method for overloaded schedule detection and notification in a C&S system includes loading a task list for an end user into memory of the C&S system. The task list includes a set of tasks scheduled for completion by the end user over a range of time. The method also includes displaying the task list in a user interface of the C&S system, comparing a capacity of the end user to complete tasks during the range of time to the tasks in the set. Finally, the method includes responding to a determination that the tasks in the last exceeds the capacity by displaying an alert in the user interface of the C&S system indicating an overloaded condition.

### BACKGROUND OF THE INVENTION

1. Field of the Invention

The present invention relates to task management in a calendaring and scheduling (C&S) system and more particularly to individual task scheduling in a C&S system.

2. Description of the Related Art

Tasks are to-dos that are recorded in a C&S system to remind the end user to complete the task at some point in the future. A task list is a list of tasks which are to be completed by the end user and, within a C&S system, may be ordered within a list alphabetically, chronologically in terms of task creation, or in order of assigned priority. In this regard, as tasks can be numerous within a task list, in an effort to assist the end user in determining a particular order in which tasks are to be completed, each task in a task list can be assigned a priority from amongst a range of priorities. In this way, the likelihood of an end user completing an important task can be increased.

The prioritization of only a few tasks in a task list can be a relatively management project, however, as tasks become numerous within a task list, properly assigning a priority to each task can be challenging. In this regard, where an end user manages dozens of tasks, assigning an appropriate priority to a new task relative to existing tasks can be nearly impossible and requires the end user to consider the assigned priority of each existing task in the task list. As and end result, managing a large task list can become a task in unto itself.

Of note, tasks are often created for the individual without consideration of other tasks scheduled for concurrent completion by the end user. Further, tasks are created for the individual, not only by the individual, but also by others as a matter of delegation. For small daily task lists, the notion of arbitrarily scheduling for concurrent completion multiple different tasks is of no consequence. However, for end users of extensive daily tasks lists, the arbitrary scheduling of many different tasks for concurrent completion can all but guarantee that the end user cannot complete all tasks in a timely fashion. Such a condition is known as an “overloaded” condition in which more tasks are scheduled for completion during a day than possible.

To the extent the end user is able to recognize an overloaded condition in which more tasks are scheduled for completion in a single day than possible, the end user can manually identify lower priority tasks able to be rescheduled and manually perform the rescheduling of those identified tasks. Yet, the manual rescheduling of tasks in a task list presupposes that the end user has a priori knowledge of the relative priority of the different tasks in a list and also the extent of population of the task lists for subsequent days in the future. Further, requiring the end user to engage in a tedious manual process of rescheduling tasks on a daily basis in many ways defeats the efficiency of an automated task list.

### BRIEF SUMMARY OF THE INVENTION

Embodiments of the present invention address deficiencies of the art in respect to overloaded task list management and provide a novel and non-obvious method, system and computer program product for overloaded schedule detection and notification in a C&S system. In an embodiment of the invention, a method for overloaded schedule detection and notification in a C&S system is provided. The method includes loading a task list for an end user into memory of the C&S system. The task list can include a set of tasks scheduled for completion by the end user over a range of time. The method also can include displaying the task list in a user interface of the C&S system, comparing a capacity of the end user to complete tasks during the range of time to the tasks in the set. Finally, the method includes responding to a determination that the tasks in the set exceeds the capacity by displaying an alert in the user interface of the C&S system indicating an overloaded condition.

In one aspect of the embodiment, in response to a determination that the tasks in the set do not exceed the capacity but is within a threshold value of the capacity, an alert is displayed in the user interface of the C&S system indicating an approaching overloaded condition. In another aspect of the embodiment, in response to the overloaded condition, a task in the set of tasks is selected, a future day when the selected task can be re-scheduled without causing an overloaded condition in the future day is determined, and the end user is prompted in the user interface of the C&S system to reschedule the selected task to the future day. In respect to the rescheduling of the selected task, wherein the selected task can be selected according to a lowest priority from amongst the set of tasks, or the selected task can be selected from amongst the set of tasks according to a combination of known time consumption and priority of the selected task.

In another embodiment of the invention, a calendaring and scheduling (C&S) data processing system is configured for overloaded schedule detection and notification and includes a host server computing system, a database of tasks scheduled for an end user of the C&S system and a C&S system executing in the host server computing system. Finally, an overloaded schedule detection and notification module of the C&S system can be provided. The module can include program code enabled upon execution in the memory of the host server computing system to load a task list for the end user in the C&S system, the task list comprising a set of tasks scheduled in the database for completion by the end user over a range of time, to display the task list in a user interface of the C&S system, to compare a capacity of the end user to complete tasks during the range of time to the tasks in the set, and to respond to a determination that the tasks in the set exceeds the capacity by displaying an alert in the user interface of the C&S system indicating an overloaded condition.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for overloaded schedule detection and notification in a C&S system;

FIG. 2 is a schematic illustration of a C&S data processing system configured for overloaded schedule detection and notification; and,

FIG. 3 is a flow chart illustrating a process for overloaded schedule detection and notification in a C&S system.

### DETAILED DESCRIPTION OF THE INVENTION

Embodiments of the invention provide for overloaded schedule detection and notification in a C&S system. In accordance with an embodiment of the invention, a task list of tasks scheduled for an individual within a range of time can be loaded into memory of a computer. A known capacity of the individual to complete a set of tasks within the range of time can be determined and compared to the list of tasks and a determination made whether or not all of the tasks in the list of tasks can be completed within the range of time. If not, an alert can be presented in a user interface to the individual alerting the individual as to the overloaded condition. Optionally, a different alert can be presented in the user interface responsive to a determination that while the list of tasks is able to be completed within the range of time, the list of tasks is within a threshold of not being able to be completed. As even yet another option, when it is determined that the list of tasks is unable to be completed within the range of time, one or more tasks in the list can be suggested for rescheduling for a particular day such that the rescheduling of the tasks for the particular day will not result in an overloaded condition for the particular day.

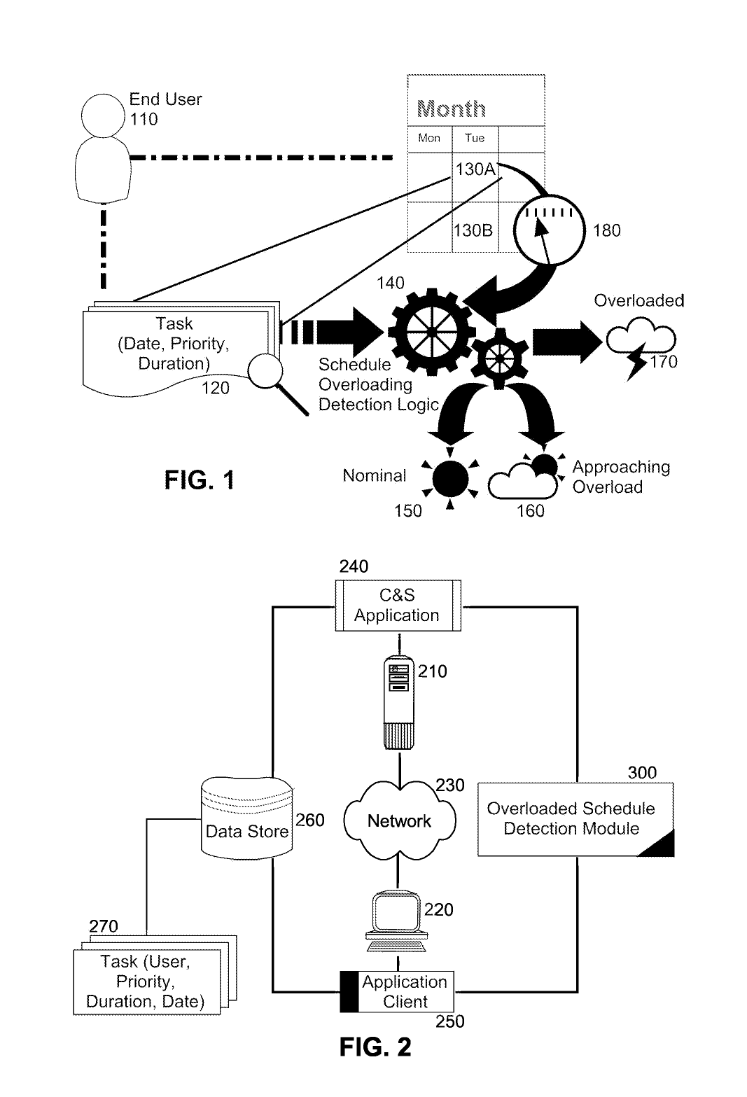

In illustration, FIG. 1 pictorially shows a process for overloaded schedule detection and notification in a C&S system. As shown in FIG. 1, schedule overloading detection logic 140 can analyze different scheduled tasks 120 for an end user 110 of a C&S system for a particular range of time 130A to determine whether or not the tasks 120 are able to completed within the particular range of time 130. For example, a total amount of time required for each of the tasks 120 can be summed and compared to a pre-determined available amount of time 180 for the particular range of time 130A. Subsequently, the schedule overloading detection logic 140 can present in a user interface for the C&S system an alert 170 indicating that the particular range of time 130A is overloaded due to the determination that the tasks 120 are able to completed within the particular range of time 130A. Otherwise, the schedule overloading detection logic 140 can present in the user interface an indication of nominal scheduling 150.

Optionally, the schedule overloading and detection logic 140 can determine that while the tasks 120 are able to completed within the particular range of time 130A the amount of time required to complete the tasks 120 is within a threshold value of an amount of time available to complete the tasks 120 for the particular range of time 130A. If so, the schedule overloading detection logic 140 can identify a next available range of time 130B able to accommodate a rescheduling of one or more of the tasks 120 without giving rise to an overloaded condition. As such, a prompt 160 can be provided to the end user 110 in the user interface indicating that an overloaded condition for the particular range of time 130A is possible and proposing one or more of the tasks 120 to be rescheduled to the next available range of time 130B.

The process described in connection with FIG. 1 can be implemented within a C&S data processing system. In further illustration, FIG. 2 schematically shows a C&S data processing system configured for overloaded schedule detection and notification. The system can include a server computing system 210 that includes one or more computers, each with at least one processor and memory and supporting the operation of a C&S application 240. The server computing system 210 can be coupled over computer communications network 230 to a client computer 220 with at least one processor and memory and supporting the operation of an application client 250 accessing the C&S application 240.

The C&S application 240 and the application client 250 can access a data store 260 disposed in either or both of the server computing system 210 and the client computer 220. The data store 260 can include a set of tasks 270. Each of the tasks 270 can be associated with a particular end user, an assigned priority, and a date upon which the task is to be completed. Of note, an overloaded schedule detection module 300 can be coupled to either or both of the C&S application 240 and the application client 250. The overloaded schedule detection logic 300 can include program code that when executed in the memory of the server computing system 210 or the client computer 220 is enabled to detect for a specific day whether or not too many of the tasks 270 have been scheduled so as to have created an overloaded condition for the specific day. In response to detecting the overloaded condition, the program code can generate an alert for display in the application client 250

The program code further can be enabled to detect for a specific day whether or not so many of the tasks 270 have been scheduled so as to have created within a threshold amount of time, an overloaded condition for the specific day. Finally, the program code can be enabled to select one or more of the tasks 270 scheduled for a day in which an overloaded condition has been determined. Thereafter, a different day can be selected in which the addition of the selected tasks is computed not to cause an overloaded condition. Finally, the program code of the overloaded schedule detection logic 300 can generate a prompt in connection with the alert suggesting the rescheduling of the selected tasks to the different day.

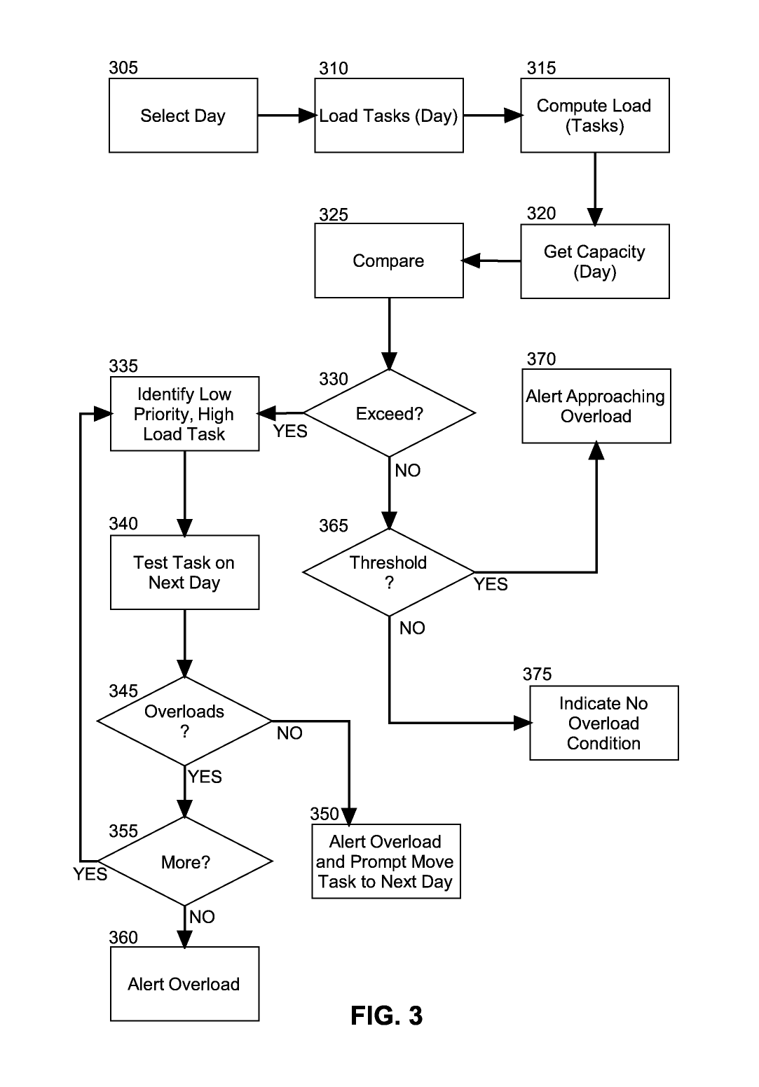

In even yet further illustration of the operation of the overloaded schedule detection logic 300, FIG. 3 is a flow chart illustrating a process for overloaded schedule detection and notification in a C&S system. Beginning in block 305, a day can be selected on a calendar for an end user of a C&S system. In block 310, tasks scheduled for the selected day for the end user can be loaded into memory and in block 315, a load associated with the selected tasks can be determined. The load can specify a number of tasks for each priority value scheduled for the day, a number of tasks in total, or an amount of time necessary to perform the tasks scheduled for the day, to name only a few examples of the load.

In block 320, a capacity for the day of scheduled tasks can be determined and compared in block 325 to the determined load. In decision block 330, if it is determined that the load does not exceed the capacity, in decision block 365, it can further be determined whether or not the load is within a threshold value of the capacity. If not, in block 375 an indication can be provided through a user interface to the C&S system that no overloaded condition exists for the day. Otherwise, in block 370, an alert can be provided in the user interface indicating that while no overloaded condition presently exists for the day, an overloaded condition is possible with the scheduling of additional tasks for that day—in other words, the end user is likely to have a very busy day addressing the scheduled tasks for the day.

In decision block 330, if it is determined that the load exceeds the capacity of the day, in block 335 a task amongst the scheduled tasks can be identified for rescheduling. For instance, a lowest priority task amongst the scheduled tasks can be selected. As another example, a task with a highest load, but lowest priority can be selected. Of course, multiple combinations of tasks of low priority, high load or both can be selected. In any event, in block 340, a different day can be inspected and the identified task hypothetically scheduled on the different day, for example a next day. In decision block 345, it can be determined whether or not the hypothetical scheduling of the identified task on the different day is likely to cause an overloaded condition on the different day.

If not, in block 350 an alert can be presented through the user interface of the C&S application that an overloaded condition exists for the day and a prompt can be provided in the user interface to reschedule the identified task or tasks to the different day. Otherwise, in decision block 355 if more tasks remain to be analyzed in the selected tasks, the process can return to block 335 in an effort to identify at least one task able to be rescheduled to the different day without creating an overloaded condition in the different day. If not tasks amongst the selected tasks can be determined as candidates for rescheduling, then in block 360 the end user can be alerted to the overloaded condition in the day without prompting for rescheduling of any tasks.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for overloaded schedule detection and notification in a calendaring and scheduling (C&S) system, the method comprising:
loading a task list for an end user into memory of the C&S system, the task list comprising a set of tasks scheduled for completion by the end user over a range of time;
displaying the task list in a user interface of the C&S system;
comparing a capacity of the end user to complete tasks during the range of time to the tasks in the set; and,
responsive to a determination that the tasks in the set exceeds the capacity, displaying an alert in the user interface of the C&S system indicating an overloaded condition.

2. The method of claim 1, further comprising responsive to a determination that the tasks in the set do not exceed the capacity but is within a threshold value of the capacity, displaying an alert in the user interface of the C&S system indicating an approaching overloaded condition.

3. The method of claim 1, further comprising, in response to the overloaded condition, selecting a task in the set of tasks, determining a future day when the selected task can be re-scheduled without causing an overloaded condition in the future day, and prompting the end user in the user interface of the C&S system to reschedule the selected task to the future day.

4. The method of claim 3, wherein the selected task is selected according to a lowest priority from amongst the set of tasks.

5. The method of claim 3, wherein the selected task is selected from amongst the set of tasks according to a combination of known time consumption and priority of the selected task.

6. A calendaring and scheduling (C&S) data processing system configured for overloaded schedule detection and notification, the system comprising:
a host server computing system comprising at least one server with memory and at least one processor;
a database of tasks scheduled for an end user of the C&S system;
a C&S system executing in the host server computing system and coupled to the database, the C&S system managing scheduling and completion of different tasks in the database; and,
an overloaded schedule detection and notification module of the C&S system, the module comprising program code enabled upon execution in the memory of the host server computing system to load a task list for the end user in the C&S system, the task list comprising a set of tasks scheduled in the database for completion by the end user over a range of time, to display the task list in a user interface of the C&S system, to compare a capacity of the end user to complete tasks during the range of time to the tasks in the set, and to respond to a determination that the tasks in the set exceeds the capacity by displaying an alert in the user interface of the C&S system indicating an overloaded condition.

7. The system of claim 6, wherein the program code is further enabled to respond to a determination that the tasks in the set do not exceed the capacity, but is within a threshold value of the capacity, by displaying an alert in the user interface of the C&S system indicating an approaching overloaded condition.

8. The system of claim 6, wherein the program code is further enabled to respond to the overloaded condition by selecting a task in the set of tasks, by determining a future day when the selected task can be re-scheduled without causing an overloaded condition in the future day, and by prompting the end user in the user interface of the C&S system to reschedule the selected task to the future day.

9. The system of claim 8, wherein the selected task is selected according to a lowest priority from amongst the set of tasks.

10. The system of claim 8, wherein the selected task is selected from amongst the set of tasks according to a combination of known time consumption and priority of the selected task.

11. A computer program product for overloaded schedule detection and notification in a calendaring and scheduling (C&S) system, the computer program product comprising:
a computer readable storage medium having computer readable program code embodied therewith, the computer readable program code comprising:
computer readable program code for loading a task list for an end user into memory of the C&S system, the task list comprising a set of tasks scheduled for completion by the end user over a range of time;
computer readable program code for displaying the task list in a user interface of the C&S system;
computer readable program code for comparing a capacity of the end user to complete tasks during the range of time to the tasks in the set; and,
computer readable program code for responding to a determination that the tasks in the set exceeds the capacity, by displaying an alert in the user interface of the C&S system indicating an overloaded condition.

12. The computer program product of claim 11, further comprising computer readable program code for responding to a determination that the tasks in the set do not exceed the capacity but is within a threshold value of the capacity, by displaying an alert in the user interface of the C&S system indicating an approaching overloaded condition.

13. The computer program product of claim 11, further comprising, computer readable program code for responding to the overloaded condition by selecting a task in the set of tasks, by determining a future day when the selected task can be re-scheduled without causing an overloaded condition in the future day, and by prompting the end user in the user interface of the C&S system to reschedule the selected task to the future day.

14. The computer program product of claim 13, wherein the selected task is selected according to a lowest priority from amongst the set of tasks.

15. The computer program product of claim 13, wherein the selected task is selected from amongst the set of tasks according to a combination of known time consumption and priority of the selected task.
